(19) United States
(12) Patent Application Publication
(10) Pub. No.: US 2025/0097634 A1
(43) Pub. Date: Mar. 20, 2025

(54) METHODS AND APPARATUS TO IMPROVE BASS RESPONSE OF SPEAKERS IN PORTABLE DEVICES

(71) Applicant: Intel Corporation, Santa Clara, CA (US)

(72) Inventors: Avinash Manu Aravindan, Alappuzha (IN); Sumod Cherukkate, Bangalore (IN); Prakash Kurma Raju, Bangalore (IN); Ezekiel Poulose, Ernakulam (IN)

(21) Appl. No.: 18/467,408

(22) Filed: Sep. 14, 2023

(51) Int. Cl. H04R 1/28; H04R 1/02; H04R 7/04; H04R 7/18; H04R 31/00

(52) U.S. Cl. CPC H04R 1/2834; H04R 1/025; H04R 1/028; H04R 1/288; H04R 7/04; H04R 7/18; H04R 31/003; H04R 2499/15

(57) ABSTRACT

Methods and apparatus to improve bass response of speakers in portable devices are disclosed. An example speaker includes a speaker box having a front face and a back face, a distance between the front face and the back face being less than 1 inch. The speaker box has a first portion of a back volume and a second portion of the back volume, the first portion of the back volume defined between the back face and a first region of the front face, the second portion of the back volume defined between the back face a second region of the front face. The example speaker further includes an active speaker driver including a first diaphragm, the first diaphragm coupled to the first region of the front face. The example speaker also includes a second diaphragm coupled to the second region of the front face, the second diaphragm being passive.

### FIELD OF THE DISCLOSURE

This disclosure relates generally to speakers and, more particularly, to methods and apparatus to improve bass response of speakers in portable devices.

### BACKGROUND

Audio performance of speakers in portable computer devices (e.g., mobile phones, tablets, laptops, etc.) is an important aspect of user experience. As portable computer devices continue to get smaller, there is less space for audio speakers presenting challenges to maintain audio performance.

### BRIEF DESCRIPTION OF THE DRAWINGS

FIG. 1 is a simplified cross-sectional view of an example portable device that includes an example speaker.

FIG. 2 is an isometric view of an example speaker constructed in accordance with teachings disclosed herein.

FIG. 3 is an exploded view of the example speaker of FIG. 2.

FIG. 4 is a flowchart representative of example operations to implement a method of manufacturing speakers in accordance with teaching disclosed above in connection with FIGS. 2 and 3.

FIG. 5 is a cross-sectional view of another example speaker constructed in accordance with teachings disclosed herein.

FIG. 6 is an isometric view of an example layer of sound absorbing particles.

FIG. 7 is a cross-sectional view of another example speaker constructed in accordance with teachings disclosed herein.

FIG. 8 is a cross-sectional view of another example speaker constructed in accordance with teachings disclosed herein.

FIG. 9 is a flowchart representative of example operations to implement a method of manufacturing speakers in accordance with teaching disclosed above in connection with FIGS. 5-8.

In general, the same reference numbers will be used throughout the drawing(s) and accompanying written description to refer to the same or like parts. The figures are not necessarily to scale. Instead, the thickness of the layers or regions may be enlarged in the drawings. Although the figures show layers and regions with clean lines and boundaries, some or all of these lines and/or boundaries may be idealized. In reality, the boundaries and/or lines may be unobservable, blended, and/or irregular.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified in the below description.

As used herein “substantially real time” refers to occurrence in a near instantaneous manner recognizing there may be real world delays for computing time, transmission, etc. Thus, unless otherwise specified, “substantially real time” refers to real time+1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

### DETAILED DESCRIPTION

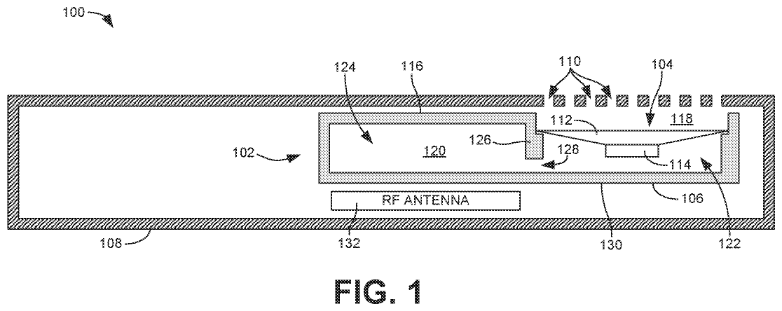

FIG. 1 is a simplified cross-sectional view of an example portable device 100 that includes an example speaker 102. The example portable device 100 can be any suitable type of portable device such as a mobile phone (e.g., a smartphone), a tablet, a laptop, etc. As shown in the illustrated example, the speaker 102 includes a speaker driver 104 (e.g., speaker transducer) coupled to and/or supported by a speaker box 106 (e.g., an enclosure, an acoustic box) that is positioned within a housing 108 of the portable device 100. As shown in FIG. 1, the speaker 102 is positioned within the housing 108 to align the speaker driver 104 with venting 110 (e.g., opening(s)) in a wall of the housing 108. The speaker driver 104 includes a diaphragm 112 that is caused to move by active components 114 associated with the speaker driver 104. As used herein, the active components 114 include a voice coil (coupled to the diaphragm 112), electrical wires to deliver current to the voice coil), and a magnet (to attract or repel the voice coil based on magnetic fields produced by the voice coil when a current is applied via the electrical wires). In this example, the diaphragm 112 is recessed relative to a front face 116 (e.g., front side) of the speaker box 106 such that there is an area 118 between the diaphragm 112 and the venting 110. This area 118 in front of the diaphragm 112 up to the air external to the portable device 100 (e.g., at the venting 110) is sometimes referred to as the front volume of the speaker 102. In some examples, the diaphragm 112 is closer to or farther from the venting 110 than what is shown in FIG. 1 to modify the size of the front volume 118

The speaker box 106 of FIG. 1 includes or defines a cavity or enclosed spaced 120 that is sometimes referred to as the back volume of the speaker 102. A larger back volume 120 lowers the frequencies at which the speaker 102 is able to produce sound. Thus, a larger back volume 120 generally corresponds to greater bass output by the speaker 102. By contrast, a smaller back volume 120 generally corresponds to less bass output. Due to the relatively small (e.g., thin) formfactors of portable devices, many back volumes 120 are side-ported or located to the side of the speaker driver 104, as shown in FIG. 1, rather than being directly behind the diaphragm 112 of the speaker driver 104. More particularly, as shown in FIG. 1, the back volume 120 includes a first portion 122 directly behind the diaphragm 112, and a second portion 124 to the side of the first portion 122. In this example, the first and second portions 122, 124 of the back volume 120 are separated by an internal wall 126 that includes a port or opening 128 to place the first and second portions 122, 124 in fluid communication. Placing the second portion 124 of the back volume 120 to the side of the first portion 122 of the back volume enables a larger back volume for better bass performance while having a total thickness for the speaker 102 (e.g., distance between the front face 116 and a back face 130 (e.g., back side)) being relatively small (e.g., less than 1 inch, less than 0.5 inches, etc.) to fit within the relatively thin formfactors typical of many portable devices 100. In some examples, the total back volume 120 is less than 5 cubic centimeters (cc) (e.g., less than 4 cc, less than 3 cc, less than 2 cc, less than 1 cc, etc.).

While a side-ported back volume 120, as shown in FIG. 1, can satisfy the thickness constraints for thin formfactor devices (e.g., the portable device 100), the back volume 120 may still be limited due to other size constraints associated with the overall formfactor of the portable device 100 and/or the placement and/or space needed for other components in the portable device 100. For instance, in many portable devices, one or more radio frequency (RF) antennas 132 are integrated with, coupled to, and/or positioned adjacent to the speaker box 106 of a speaker 102. More particularly, in some instances, as shown in FIG. 1, an antenna 132 is positioned proximate to the second portion 124 of the back volume 120 and spaced apart from the speaker driver 104 so that the active components 114 (e.g., electrical, magnetic, and/or metal components) do not interfere with the transmission and/or receipt of signals by the antenna 132. In some such situations, particular requirements for the antenna 132 may specify particular keep out zones and/or material restrictions used in the speaker 102 that can constrain the design of the speaker box 106 and/or the placement of the speaker driver 104 within the speaker box 106 relative to the antenna 132.

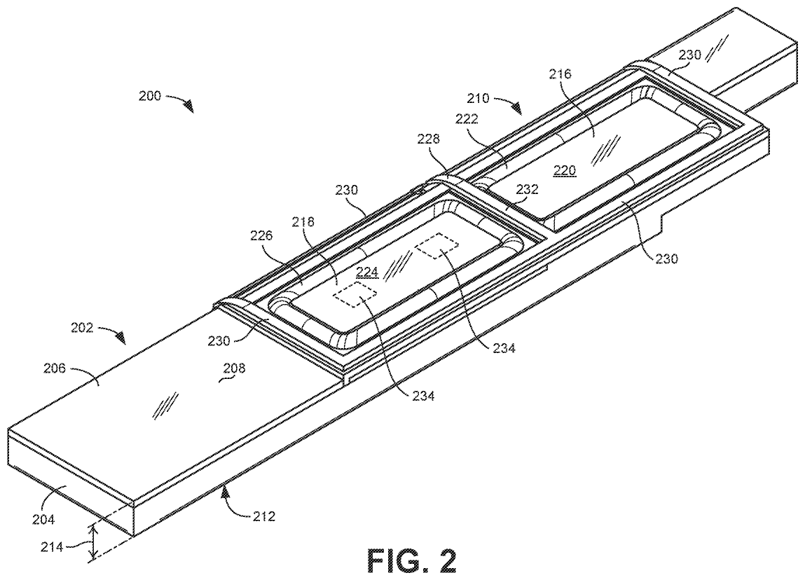

Due to the constraints placed on speakers in portable devices discussed above, the bass performance of such speakers is relatively limited. One potential solution is to include additional speakers (e.g., back to back speakers). However, in many instances, this is not a viable option because of the increased cost for the extra components as well as the space constraints (either due to overall size constraints or spatial relationship constraints relative to antennas as discussed above). Furthermore, implementing additional speakers will result in higher power consumption, thereby shortening battery life of the portable device and reducing overall user experience. Examples disclosed herein overcome some of the above challenges by implementing a speaker with a separate diaphragm that is passive and decoupled from any active components (e.g., a voice coil, electrical wires, or a magnet). Rather than being actively driven, the separate diaphragm is tuned to function in resonance with the active speaker at relatively low frequencies to give a boost to bass outputs. In some examples, the separate (passive) diaphragm is positioned on the front face 116 of the speaker box 106 in line with the second portion 124 of the back volume 120 beside the main (active) diaphragm 112. Inasmuch as the separate diaphragm is not associated with any active components (e.g., no electrical, magnetic, and/or metal components), there is no impact on the operation of the antenna 132. In some examples, the separate diaphragm is an integral extension of the active diaphragm and, therefore, sometimes referred to herein as an extended diaphragm. Specific details pertaining to example speakers that include a separate diaphragm are provided further below in connection with FIGS. 2-4.

Another option to improve the bass performance of speakers is through the use of sound absorbing filler particles disposed in the back volume. The sound absorbing particles are retained in the back volume 120 and isolated from the speaker driver 104 by a porous film or permeable membrane. The membrane is porous or permeable to permit air (and sound) to pass through while preventing the particles from passing through to potentially disrupt the operation of the speaker driver 104. The sound absorbing particles provide a non-uniform area for sound to get absorbed within the back volume 120. Furthermore, the particles absorb the sound as they move relative to one another and generate heat that is then dissipated. Such absorption of sound within the back volume 120 improves the frequency response of the speaker 102 at lower frequencies for improved bass performance. In other words, the addition of sound absorbing particles to the back volume 120 has the same effect as increasing the size of the back volume 120 without actually changing the physical dimensions of the back volume 120. Accordingly, the effective size of the back volume 120 due to the sound absorbing particles is sometimes referred to herein as the “virtual” back volume and the particles are sometimes referred to herein as “virtual materials” that give rise to a virtual back volume that is greater than the actual physical back volume.

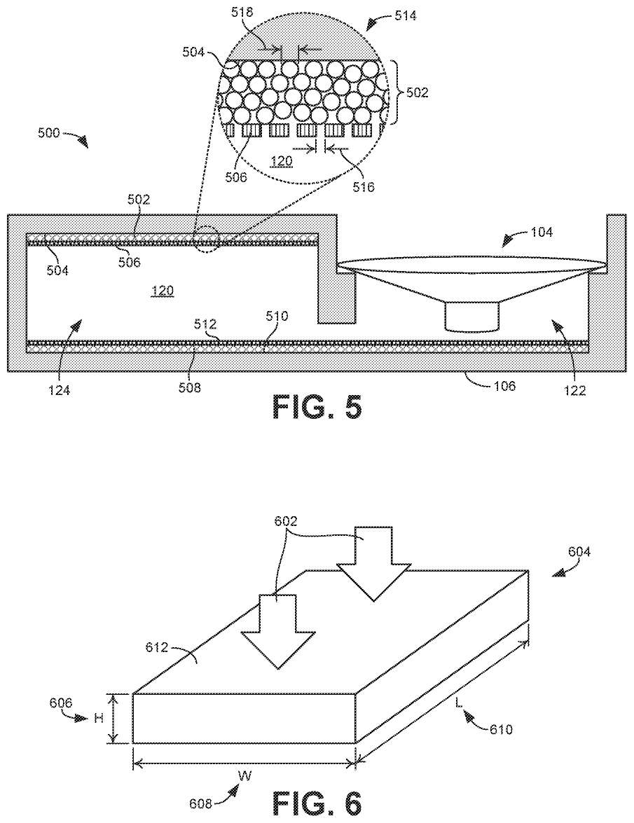

While sound absorbing particles have been shown to improve bass performance, they also present a number of disadvantages. For instance, the movement and interaction of the particles can create harmonic distortions that degrade the intended sound to be produced by a speaker. Such harmonic distortions are a function of the size of sound absorbing particles used, which is typically around 500 micrometers or larger in existing systems. Significantly smaller particles (e.g., less than 100 micrometers, less than 50 micrometers, etc.) are less likely to create such distortion problems, but such small particles present fabrication challenges. Specifically, particles with sizes less than 100 micrometers can give rise to stiction between particles due to van der Waals forces. As a result, it is difficult to separate particles of an intended size (e.g., between 10 micrometers and 100 micrometers) from much smaller particles (e.g., less than 5 micrometers) that may be sufficiently small to pass through the pores or openings in the permeable membrane so as to come into contact with and deleteriously impact the speaker driver 104. Further, due to the size of the particles, the sound absorbing particles are primarily effective in back ported speakers (in which the back volume 120 is directly behind the speaker driver 104) with much less effectiveness for side-ported speakers (in which the back volume 120 is defined by a cavity to the side of the speaker driver 104 as in FIG. 1). As a result, known sound absorbing particles have relatively limited utility in applications associated with portable devices that have relatively thin formfactors and use side-ported back volumes. Additionally, known materials used for sound absorbing particles (e.g., virtual materials) are relatively expensive and have been shown to interfere with near field effects of RF signals. As such, sound absorbing particles can negatively impact the efficiency of an antenna (e.g., the antenna 132) positioned next to the speaker 102 if the speaker 102 is filled with such sound absorbing particles. Examples disclosed herein overcome the above challenges by using low cost materials to fabricate sound absorbing particles of relatively small size (e.g., less than 100 micrometers, less than 50 micrometers, etc.) in a manner that removes much smaller particles (e.g., less than 5 micrometers) through processes that overcome the effects of van der Waals forces. Further, by using much smaller particles than known approaches, examples disclosed herein can be suitable adapted to side-ported speakers that are sufficiently thin (e.g., less than 1 inch in total thickness, less than 0.5 inches in total thickness) to be suitable for relatively thin formfactor portable devices. Specific details pertaining to example speakers that implement such sound absorbing materials are provided further below in connection with FIGS. 5-9.

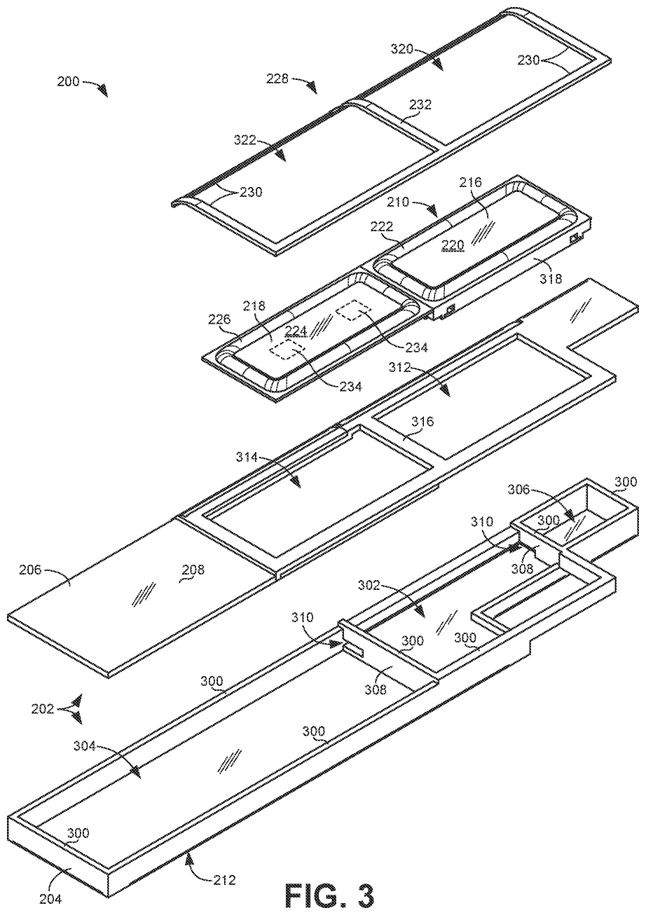

FIG. 2 is an isometric view of an example speaker 200 constructed in accordance with teachings disclosed herein. FIG. 3 is an exploded view of the example speaker 200 of FIG. 2. In some examples, the speaker 102 of FIG. 1 can be implemented by the example speaker 200 of FIGS. 2 and 3. The example speaker 200 includes a speaker box 202 defined by a base frame 204 and a front plate 206. In this examples, the front plate 206 defines a front face 208 (e.g., a front surface, a front side) of the speaker 200 that faces in the same direction that an active speaker driver 210 is facing. The base frame 204 defines a back face 212 (e.g., a back surface, a back side) of the speaker 200 that is opposite the front face 208. The example speaker 200 of FIGS. 2 and 3 is dimensioned to fit within a laptop. As such, a thickness 214 of the speaker box (between the front and back faces 208, 212) is less than 1 inch or less (e.g., less than 0.5 inches, less than 0.25 inches, etc.). As shown in the exploded view of FIG. 3, the base frame 204 includes walls 300 to which the front plate 206 is coupled to define different cavities or open spaces 302, 304, 306 therebetween that collectively define a back volume for the speaker 200. In this example, the walls 300 include internal walls 308 to separate the different cavities 302, 304, 306. The internal walls include slots, openings, or ports 310 to place the cavities 302, 304, 306 in fluid communication. In some examples, some or all of the walls 300, 308 may be coupled to the front plate 206 in addition to or instead of the base frame 204.

In this example, the front plate 206 includes a first opening 312 aligned with (e.g., that opens to) the first cavity 302 of the back volume and a second opening 314 aligned with (e.g., that opens to) the second cavity 304 of the back volume. In this example, the first and second openings 312, 314 are separated by an arm 316 that is aligned with the internal wall 308 between the first and second cavities 302, 304. The first opening 312 is dimensioned to receive the active speaker driver 210. The active speaker driver 210 includes a first diaphragm 216 coupled to associated active components 318 (e.g., a voice coil, electrical wires, a magnet, etc.). The second opening 314 in the front plate 206 is dimensioned to receive a second diaphragm 218. Thus, the first and second diaphragms 216, 218 are positioned adjacent to one another. In this example, the first diaphragm 216 includes a first central plate 220 and a first resilient rim 222 surrounding the first central plate 220. Similarly, the second diaphragm 216 includes a second central plate 224 and a second resilient rim 226 surrounding the second central plate 224. The resilient rims 222, 226 are made of flexible or compliant materials (e.g., a plastic, a polymer, etc.) that function like a spring to enable the central plates 220, 224 of the diaphragms 216, 218 to deflect in and out. The central plates 220, 224 are generally flat pieces of sound dampening material (e.g., balsa wood, a plastic, a polymer, etc.) to reduce distortions. In other examples, the diaphragms 216, 218 can have a different design and/or shape other than what is shown.

As shown in the illustrated example, the first and second diaphragms 216, 218 are held in place by a gasket 228. In this example, the gasket 228 is a unitary component defined by an outer rim 230 dimensioned to surround both diaphragms 216, 218. Further, in this example, the gasket 228 includes an arm 232 extending between opposites sides of the outer rim 230 to define separate first and second openings 320, 322. In this example, the first opening 320 is dimensioned to fit around the first diaphragm 216 of the active speaker driver 210 and the second opening 322 is dimensioned to fit around the second (passive) diaphragm 218. As shown in the illustrated example of FIG. 2, the arm 232 is positioned to overlap the interfacing edges of the two diaphragms 216, 218 and/or to overlap the interfacing region of the two diaphragms 216, 218. Further, the arm 232 of the gasket 228 is to be aligned with the arm 316 of the front plate 206, which is also aligned with the internal wall 308. Thus, the edges of the two diaphragms 216, 218 and/or the associated interfacing region of the two diaphragms 216, 218 is also aligned with the underlying internal wall 308.

In this example, the second diaphragm 218 is coupled to the front plate 206 without (e.g., independent of) active components. That is, in this example, the second diaphragm 218 is not coupled to or associated with a voice coil, is not coupled to or associated with electrical wires, and is not coupled to or associated with a magnet. Thus, the second diaphragm 218 functions as a passive decoupled diaphragm separate from the first diaphragm 216. In some examples, the second diaphragm 218 is a functional replica of the first diaphragm 216. That is, in some examples, the second diaphragm 218 has the same size and shape as the first diaphragm 216. Further, in some examples, the second diaphragm 218 is made of the same materials as the first diaphragm 216. In some examples, the second diaphragm 218 is a duplicate component of the first diaphragm 216. In some examples, both the first and second diaphragms 216, 218 can be fabricated in the same fabrication process(es), thereby reducing manufacturing complexity and costs. For instance, in some examples, the diaphragms 216, 218 may be fabricated at the same time using a single injection molding process and/or any other suitable fabrication process(es). In some examples, the first and second diaphragms 216, 218 are integrally formed (e.g., both diaphragms are injection molded as a unitary component). Accordingly, in some examples, the second diaphragm 218 is an extension of the first diaphragm 216 and is sometimes referred to herein as an extended diaphragm. As used herein, extended diaphragm also applies to situations where the second diaphragm 218 is separate from the first diaphragm 216 but nevertheless positioned adjacent to the first diaphragm 216 so as to extend away from the first diaphragm 216.

While fabricated with the same size, shape, and materials, in some examples, the thickness of the materials used in the second diaphragm 218 are different than the thickness of the materials used in the first diaphragm 216 to modify a compliance of the second diaphragm 218 relative to the first diaphragm 216 (e.g., a compliance of the second resilient rim 226 relative to the first resilient rim 222). More particularly, in some examples, the second diaphragm 218 is more compliant (e.g., less stiff) than the first diaphragm 216. In other examples, the second diaphragm 218 is manufactured using different materials than used for the first diaphragm 216 to produce a difference in compliance between the two diaphragms. Additionally or alternatively, in some examples, additional materials are added to the second diaphragm 218 to modify the compliance of the second diaphragm 218. For instance, in some examples, one or more weights 234 are added to the second diaphragm 218. In the illustrated example, the weights 234 are weighted stickers adhered to an underside of the central plate 224 of the second diaphragm 218. In some examples, the weights can be any suitable weight (e.g., from 1 gram to 25 grams).

In some examples, the amount of weight added and/or the adjustments to the compliance of the second diaphragm 218 relative to the first diaphragm 216 is tuned so that the second diaphragm 218 operates in resonance with the first diaphragm 216 at relatively low frequencies (associated with bass sounds (e.g., in a range between approximately 80 Hz and approximately 200 Hz)) to give a boost in the sound pressure level (SPL) at such frequencies. That is, whereas the first diaphragm 216 is associated with an active speaker driver 210 (operated based on electrical current passing through a voice coil that interacts with a magnet), the second diaphragm 218 works passively (without the need for any active circuits) from sound pressure within the sealed speaker box 202 produced by movement of the (actively driven) first diaphragm 216. At higher frequencies (e.g., above 200 Hz), the second diaphragm 218 will function as a rigid wall of the sealed speaker box 202 due to the higher compliance of the second diaphragm 218 at those frequencies. In other words, the second diaphragm 218 with the added weight(s) 234 works on the same principle as a weight suspended on a spring that produces large deflection/displacement at lower frequencies and negligible deflection/displacement at higher frequencies. Furthermore, the frequency response characteristics of the second diaphragm 218 produce a dampening effect for the active speaker driver 210 (including the associated second diaphragm 216), thereby reducing the risk of overdrive and/or blow out of the active speaker driver 210, without compromising performance. Further, such dampening effects relax the constraints on the smart amplifier implemented for the active speaker driver 210. Further still, this dampening effect can result in a smaller displacement of the first diaphragm 216, thereby reducing complexity in the construction of the speaker 200.

In some examples, to achieve the correct resonance, the weight of the second diaphragm 218 (including the added weights 234) is adjusted to correspond to the weight of the air in the back volume of the speaker 200 to give a proper impedance matching. More particularly, the resonance frequency of the second diaphragm 218 can be calculated as

$$f = \sqrt{\frac{1}{4 {π}^{2} * {M}_{res} * {C}_{msr}}} \qquad Eq . 1$$

where f is the resonance frequency (Hz), Cₘₛᵣ is the resulting compliance of the acoustics box (e.g., the speaker box 202), and Mᵣₑₛ is the effective mass of the diaphragm (kg). As indicated by Equation 1, adding weights to the diaphragm will lower the resonance frequency. The specific tuning of the weight for a given speaker (e.g., the speaker 200) will depend on the system parameters like porting, front volume, back volume, etc.

The resonant frequency of the entire speaker 200 (including the active speaker driver 210 with the first diaphragm 216 and the second (passive) diaphragm 218) can be calculated as

$${f}_{0} = \frac{1}{2 π} \sqrt{\frac{{k}_{s} + {k}_{d}}{{m}_{s} + {m}_{d}}} \qquad Eq . 2$$

where f₀ is the resonance frequency of the system (Hz), kₛ is the stiffness of the active speaker (e.g., the first diaphragm 216) (N/m), k_{d} is the stiffness (e.g., compliance) of the extended diaphragm (e.g., the second diaphragm 218) (N/m), mₛ is the effective mass of the first (active) diaphragm 216 (kg), and ma is the effective mass of the second (passive) diaphragm 218 (kg). Further, the resistance (R_{d}), quality factor (Q_{d}), and deflection (D_{d}) of the extended diaphragm (e.g., the second diaphragm 216) can be calculated as

$${R}_{d} = 2 ζ \sqrt{\frac{{m}_{d}}{{k}_{d}}} \qquad Eq . 3$$

$${Q}_{d} = \frac{2 π {f}_{0} {m}_{d}}{{R}_{d}} \qquad Eq . 4$$

$${D}_{d} = \frac{{V}_{e} ρ {c}^{2} {S}_{d}}{{k}_{d} ( {ω}^{2} - {ω}_{0}^{2} + 2 {ζω}_{0} ω i )} \qquad Eq . 5$$

wherein ζ is the damping coefficient of the system, Vₑ is the volume of the enclosure (e.g., the back volume), ρ is the density of air, c is the speed of sound, S_{d} is the effective radiating area of extended diaphragm, ω is the angular frequency of the driver, and ω₀ is the angular resonant frequency of the extended diaphragm.

As evident from the Equation 2, the stiffness of the second diaphragm 218 needs to be lower than the first diaphragm 216 and the mass needs to be higher to keep the resonant frequency of the system low. However, keeping the stiffness of the second diaphragm 218 too low and/or the mass too high will lower the quality factor of the extended diaphragm (as indicated by Equation 4). A higher quality factor results in better efficiency of the system.

Another design consideration is the deflection of the second diaphragm 218. According to Equation 5, the deflection of the second diaphragm 218 needs to be more than the second diaphragm 216 to increase (e.g., maximum) performance of the system. Thus, there needs to be balance between the stiffness and the mass of the second diaphragm 218 for proper working, taking into account the target resonance frequency, quality factor, and deflection of the diaphragm 218.

It can be difficult and/or impractical to adjust the stiffness of the second diaphragm 218 to a precise amount relative to the first diaphragm 216. Accordingly, in some examples, the second diaphragm is constructed with a material having more compliance (e.g., lower stiffness) than the second diaphragm 216, as per the equations above. From there, the mass of the second diaphragm 218 can be adjusted relatively easily by adding the weight(s) 234 as discussed above.

As discussed above, the example speaker 102 of FIG. 1 can be implemented by the example speaker 200 of FIGS. 2 and 3. In such an example, the speaker driver 210 of FIGS. 2 and 3 correspond to the speaker driver 104 of FIG. 1 and the second diaphragm 218 of FIGS. 2 and 3 would be added on the front face 116 of the speaker box 106 in alignment with the second portion 124 of the back volume 120. Further, in such examples, additional venting (similar to the venting 110 shown adjacent to the speaker driver 104 in FIG. 1) may be added to the housing 108 adjacent to the added second diaphragm 218. Significantly, inasmuch as there are no active components (e.g., no electrical wires or metal) associated with the second diaphragm 218, positioning the second diaphragm 218 adjacent to the second portion 124 of the back volume 120 will not interfere with the operations of the RF antenna 132 located proximate to the second portion 124 of the back volume 120.

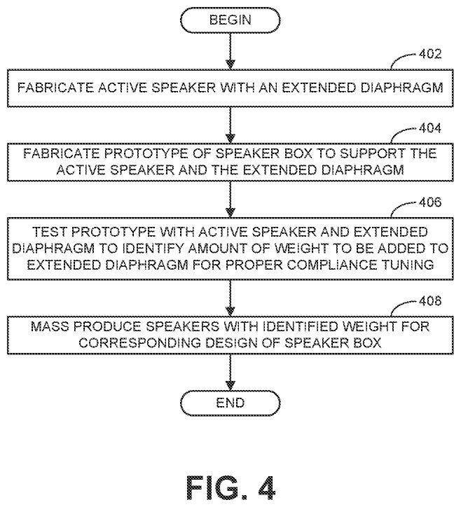

FIG. 4 is a flowchart representative of example operations to implement a method of manufacturing speakers in accordance with teaching disclosed above in connection with FIGS. 2 and 3. In some examples, some or all of the operations outlined in the FIG. 4 are performed automatically by fabrication equipment that is programmed to perform the operations. Although the example method of manufacture is described with reference to the flowchart illustrated in FIG. 4, many other methods may alternatively be used. For example, the order of execution of the blocks may be changed, and/or some of the blocks described may be combined, divided, re-arranged, omitted, eliminated, and/or implemented in any other way. Further, in some examples, additional processing operations can be performed before, between, and/or after any of the blocks represented in the illustrated example.

The example process begins at block 402 where an active speaker (e.g., the speaker driver 210 with the first diaphragm 216) is fabricated with an extended diaphragm (e.g., the second diaphragm 218). As discussed above, in some examples, both the first and second diaphragms 216, 218 are fabricated in the same process (e.g., during the same injection molding process). More particularly, in some examples, the second diaphragm 218 is integrally formed (e.g., as an extension of) the first diaphragm 216. In other examples, block 402 can be separated into multiple operations with the diaphragms 216, 218 being separately fabricated.

At block 404, the example process includes fabricating a prototype of a speaker box (e.g., the speaker box 202) to support the active speaker (e.g., the speaker driver 210 with the first diaphragm 216) and the extended diaphragm (e.g., the second diaphragm 218). At block 406, the example process includes testing the prototype with the active speaker and the extended diaphragm to identify the amount of weight to be added to the extended diaphragm for proper compliance tuning. In some examples, the amount of weight to be added can be done through trial and error. Additionally or alternatively, approximate values for the amount of the weight can be calculated and then confirmed through testing. If only one speaker is needed, the example process can end here, and the prototype can function as the final product. However, the process can continue to block 408 where speakers are mass produced with the identified weight for the corresponding design of the speaker box. That is, once the proper amount of weight is identified for a particular speaker box design, the testing does not need to be repeated but the weight can simply be added to the extended diaphragm (e.g., the second diaphragm 218) in subsequent instances of the speaker assembly. Further, the same speaker box can be used for different speaker designs (tuned to different frequencies) simply by adjusting the amount of weight added to the extended diaphragm. Thereafter, the example process of FIG. 4 ends.

FIG. 5 is a cross-sectional view of another example speaker 500 constructed in accordance with teachings disclosed herein. In some examples, the speaker 102 of FIG. 1 can be implemented by the example speaker 500 of FIG. 5. The speaker 500 of FIG. 5 has a similar construction to the speaker 102 in FIG. 1. Accordingly, the same reference numbers will be used for similar parts. Thus, the example speaker 500 includes a speaker box 106 that supports a speaker driver 104 and defines a back volume 120 (that includes first and second portions 122, 124). In addition to the basic structure shown in FIG. 1, the example speaker 500 includes a first layer of sound absorbing particles 502 (e.g., virtual material) held in place against a first inner surface 504 of the back volume 120 by a first membrane 506. Further, in this example, the speaker 500 includes a second layer of sound absorbing particles 508 (e.g., virtual material) held in place against a second inner surface 510 of the back volume 120 by a second membrane 512. In some examples, one of the first or second layers of sound absorbing particles 502, 508 (along with the corresponding membrane 506, 512) may be omitted and/or located at a different location (e.g., along the side walls of the back volume 120). In some examples, additional layers of the sound absorbing materials (other than the first and second layers 502, 508) may be included against other inner surfaces (e.g., the side walls of the back volume 120). In the illustrated example, the first and second layers of particles 502, 508 extend a full way across the corresponding inner surfaces 504, 510. However, in other examples, one or both of the layers of particles 502, 508 may extend less than the full distance across the corresponding surfaces 504, 510.

An enlarged view 514 of a portion of the first layer of sound absorbing particles 502 is shown in FIG. 5. The description of the first layer of sound absorbing particles 502 applies equally to the second layer of sound absorbing materials except as otherwise indicating herein. As shown in the enlarged view 514, the membrane 506 is porous or permeable with holes, openings, or pores having a first dimension 516. In this example, the first dimension 516 of the holes, openings, or pores in the membrane 506 is smaller than a second dimension 518 associated the size of the sound absorbing particles. In the enlarged view 514 of the illustrated example of FIG. 5, although the particles in the illustrated example are all shown as having a circular cross-section, in some examples, the particles can have different shapes (e.g., oval, rectangular, triangular, irregular, elongate strands, etc.). Further, in the illustrated example all of the particles are shown as being the same size. However, in some examples, there may be some variation in the sizes of different ones of the particles spanning a certain range. In some examples, the lower end of the range in the size of the particles is to be larger than the first dimension 516 so that none of the particles are able to pass through the membrane 506. For instance, in some examples, a smallest dimension for the particles is intended to be at least 5 micrometers or any other suitable limit (e.g., at least 2 micrometers, at least 10 micrometers, etc.). In some examples, the upper end of the range in the second dimension 518 associated with the size of the particles is less than 100 micrometers or less (e.g., less than 75 micrometers, less than 50 micrometers, less than 40 micrometers, less than 25 micrometers, etc.). Thus, in some examples, the sound absorbing particles are sufficiently small to constitute a powder. In some examples, the particles in the layer are fabricated from any suitable sound absorbing material (e.g., activated carbon, nanoparticles, graphene, polypropylene fabric strands, etc.).

The sound absorbing properties of the particles in the layers of particles 502, 508 serve to absorb sound energy and reduce internal reflections within the speaker box 106. Reducing internal reflections helps to improve the clarity and accuracy of the sound reproduced by the speaker 500. For particles to absorb sound in this manner to achieve this benefit, the acoustic impedance of the material needs to be lower than or equal to the acoustic impedance of the air volume, which results in an effective increase or higher “virtual” back volume. If the acoustic impedance is higher than the air volume, the particles will reduce the effective size of the back volume and degrade speaker performance. The acoustic impedance of air is approximately 415 Rayls.

The acoustic impedance for porous materials such as the layers of sound absorbing particles 502, 508 can be calculated using the Delany-Bazley model. This model indicates the dependence of the acoustic impedance of a material on the flow resistivity of the material and the porosity of the material. The acoustic impedance can be expressed mathematically as

$${Z}_{a} = ρ c ( 1 + 0.0571 {φ ( \frac{- j ρ c}{{σ}_{f}} )}^{1.3} ) \qquad Eq . 6$$

where Z_{α} is the acoustic impedance of the material, ρ is the density of the material, c is the speed of the sound in the material, φ is the porosity of the material (expressed as decimal), j is the imaginary unit, and σ_{f} is the flow resistivity of the material (in Rayls/m).

The flow resistivity, which quantifies the resistance to the flow of air or sound waves, is an important factor in determining the sound absorption characteristics of porous materials. The higher the flow resistivity, the more sound energy gets absorbed. Flow resistivity depends on the geometry, structure and composition of the material. Further, flow resistivity is influenced by factors such as the material's porosity, tortuosity (the degree of winding or twisting of the porous pathways), and the size and shape of the pores or voids within the material. Flow resistivity of a porous material can be estimated using the following equation (Delany-Bazley model)

$${σ}_{f} = \frac{( ρ c ) {( 1 - φ )}^{2}}{8 {φ}^{2}} \qquad Eq . 7$$

The flow resistivity can vary significantly between different materials and even within the same material under different conditions. Flow resistivity is typically measured by experimental methods, by measuring the sound absorption properties of the material at different frequencies and using mathematical models to extract the flow resistivity value.

Using very fine or small particles (e.g., powders) with a maximum size less than 100 micrometers (if not significantly smaller), provide many advantages as a virtual material that increase the virtual back volume of a speaker. For instance, powder materials often have a high porosity due to their fine particle size and irregular shape. Such porosity allows for the penetration and dissipation of sound waves within the material, leading to effective sound absorption. Additionally, the irregular shape and arrangement of powder particles create a tortuous path for sound waves to travel through the material. Such tortuosity enhances sound wave attenuation by increasing the path length, resulting in better absorption. Further, the fine particles in powder materials provide a large surface area per unit volume. A large surface area promotes sound wave interaction and energy dissipation, leading to improved absorption performance. Furthermore, smaller particle sizes, combined with lower density, enables microscopic mechanical movement between the particles, which further enhances sound absorption. Relatedly, given the smaller particle size, the mechanical interaction between the particles does not create any significant noise that will give rise to total harmonic distortion (THD) degradation. Further still, powder materials offer versatility in terms of composition, particle size, and surface treatments. This versatility allows for tailoring the sound absorption properties to specific requirements, such as increasing (e.g., optimizing) absorption at particular frequencies or achieving desired acoustic performance in different environments. Also, depending on the particle size distribution and material composition, powder materials can exhibit broadband sound absorption characteristics, effectively attenuating sound across a wide frequency range. Additionally, powder materials can be easily applied or integrated into various forms, such as loose fill, porous panels, or coatings. This flexibility makes it easier to integrate in small speaker box designs.

For power type materials (e.g., particles small than 100 micrometers), porosity and tortuosity are largely determined by the particle sizes. The approximate relation between porosity and particle size is given by Kozeny-Carman equation, which may be expressed as

$$φ = \frac{{ε}^{3}}{{{C}^{2} ( 1 - ε )}^{2}} * \frac{{d}^{2}}{180} \qquad Eq . 8$$

where φ is the porosity of the material (expressed as decimal), ε is the void fraction, C is the Kozeny-Carman constant, and d is the particle diameter. While Equation 8 is merely an approximation, the equation shows that porosity is directly proportional to particle size. Thus, the maximum particle size that can be used for effective sound absorption in a speaker box is determined by the acoustic impedance requirement for the given material. Inasmuch as the maximum particle size will be different for different materials and even for the same material under different conditions and/or surface treatments, the maximum particle size for a given speaker is determined experimentally in some examples. While the maximum particle size can vary across different use cases, in some examples, the minimum particle size is driven by the size of the pores or openings in the membrane (e.g., driven by the first dimension 516 shown in FIG. 5). The membrane is porous so as to be breathable or air permeable to permit sound pressure to pass through and interact with the sound absorbing particles. However, the membrane having openings smaller than the smallest particles serves to prevent the particles from passing through and polluting the components of the speaker driver 104.

Fabricating particles with sizes between the minimum and maximum particle sizes discussed above is difficult because of the relatively small size of the particles. Specifically, with maximum sizes being less than 100 micrometers, van der Waals forces can have a significant effect on the interactions of the particles causing them to stick together. This creates challenges of removing particles smaller than the lower limit on the size range because such particles will stick to the larger particles (within the size range). Accordingly, in some examples, a liquid or aqueous-based differential sieving process is implemented to remove the particles smaller than minimum size limit. More particularly, in some examples, the particles are passed through a first mesh or sieve with openings corresponding to the maximum particle size and retain what passes through the mesh. In this manner, all particles above the maximum particle size discussed above will be filtered out or removed. Thereafter, a second differential sieving process is implemented using a mesh or sieve with openings corresponding to the minimum particle size with the particles that do not pass through the openings being retained. In this manner, particles smaller than minimum particle size discussed above will be filtered out or removed. However, as discussed above, there is some risk that van der Waals forces will cause some small particles (below the minimum particle size) to cling or stick to larger particles (within the desired minimum and maximum size range). Accordingly, in some examples, during the second differential sieving process, the particles are passed through the second mesh (with the smaller openings) under pressure of and/or while disposed within a liquid that will overcome the van der Waals forces for reliable sieving. In some examples, the first differential sieving process (with the mesh having the larger openings) may also involve the use of a liquid to separate the target-sized particles from the those that are larger than the maximum particle size.

Inasmuch as the particle sizes in disclosed examples are much smaller than existing approaches of implementing virtual materials (e.g., significantly less than 100 micrometers in size), such particles can be placed in much thinner layers compared to currently available techniques while still achieving similar (if not enhanced) audio performance. Furthermore, with thinner layers of the particles than in existing approaches, it is possible to position the layers in strategic locations of the speaker box to enhance the audio performance beyond what existing approaches can achieve in certain instances. In particular, experimental results show that an improved (e.g., maximum) performance boost using small sound absorbing particles (e.g., virtual material) can be achieved when the layer of particles (e.g., the layer of particles 502 in FIG. 5) has a thickness corresponding to a stack-up of at least 5 layers of the particles (e.g., the thickness is at least five times the second dimension 518).

Furthermore, experimental results show that an improved (e.g., maximum) performance boost is achieved when the acoustic interfering cross-sectional area to depth ratio is at least 1.5. As used herein, the acoustic interfering cross-sectional area is the area of the layer of particles 502 upon which acoustic sound waves are incident before they traverse through and interact with the sound absorbing particles. This is demonstrated by FIG. 6 in which the arrows 602 represent incident acoustic waves approaching a layer of particles 604 having a height (H) or thickness 606 a width (W) 608, and a length (L) 610. In this example, the acoustic interfering cross-sectional area corresponds to the top surface 612 of the layer of particles 604 defined by the width 608 and length 610. The acoustic interfering cross sectional area to penetration depth ratio (R_{AD}) can be calculated as

$${R}_{AD} = \frac{L * W}{2 ( L + W ) * H} \qquad Eq . 9$$

where, R_{AD} is acoustic interfering cross-sectional area to depth ratio, L is length of the acoustic cross-section, W is width of the acoustic cross-section, and H is depth of the acoustic cross-section.

As noted above, the ratio of Equation 9 needs to be at least 1.5 to achieve meaningful audio performance improvement. In existing approaches that use relatively large particles (e.g., at least 500 micrometers in size), the minimum height or thickness (of at least 5 layers of particles) is relatively large such that the interfering cross-sectional area also needs to be relatively large. In existing approaches for implementing sound absorbers, such an area can only be achieved by placing the sound absorbing particles directly behind the speaker driver itself. However, this necessarily adds to the overall thickness of the speaker box (due to the relatively large thickness of five layers of particles stacked up) thereby limiting the application of such techniques in thin form factor portable devices. By contrast, examples disclosed herein, that are based on much smaller particles, can result in much thinner layers of particles (including a stack-up of at least five particles) and, as a result, much smaller acoustic interfering cross-sectional area 612. Thus, the particles can easily be positioned behind the speaker driver 104 as shown in FIG. 5 without having a significant (if any) impact on the overall thickness of the speaker box 106. Moreover, the particles can also be easily placed inside the ported back volume (e.g., the second portion 124 of the back volume 120 shown in FIG. 5) to increase the acoustic interfering cross-sectional area so that the ratio defined in Equation 9 is at least 1.5.

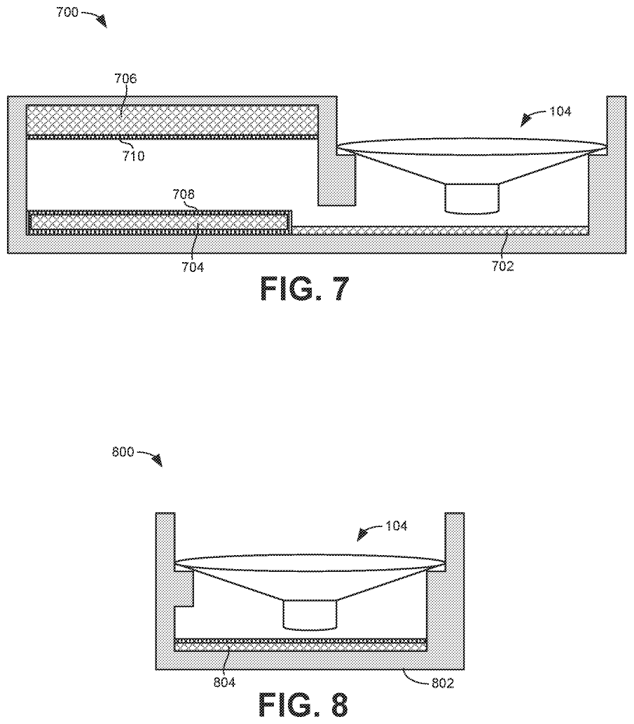

In the illustrated example of FIG. 5, the acoustic interfering cross-sectional area corresponds to the total combined area of both the first layer of particles 502 and the second layer of particles 508. In some examples, because the area is effectively doubled by having two separate layers of particles 502, 508 on opposing surfaces on the inside of the speaker box 106, the layer of particles directly behind the speaker driver 104 (e.g., within the first portion 122 of the back volume 120) may be omitted. In some examples, additional layers of particles may additionally or alternatively be added to the side walls of the speaker box 106. Other arrangements are also possible. For instance, FIG. 7 illustrates another example speaker 700 with a first layer of particles 702 directly behind the speaker driver 104, a second layer of particles 704 adjacent to the first layer of particles 702, and a third layer of particles 706 on an inner surface of the back volume opposite the second layer of particles 704. In this example, each of the first, second, and third layers of particles 702, 704, 706 have different thicknesses. While the third layer of particles 706 is shown as the thickest, in other examples, either the first or second layers of particles 702, 704 may be the thickest. Similarly, any one of the layers of particles 702, 704, 706 may be thinner than the others. In some examples, two of the layers of particles 702, 704, 706 may have the same thickness with the thickness of the third layer being different than the others. In some examples, the thicknesses of the layers of particles 502, 508 may likewise differ in any suitable manner.

Part of the reason the first layer of particles 702 is as thin as it is, as shown in FIG. 7, is due to the absence of a membrane (whereas both the second and third layers of particles 704, 706 are associated with corresponding membranes 708, 710). As discussed above, in some examples, the membranes 708, 710 serve to retain the particles in position and keep the particles away from the speaker driver 104. In some examples, the first layer of particles 702 is applied as a surface coating with an adhesive material that bonds the particles together so that a membrane to retain the particles becomes unnecessary. In some examples, the surface coating includes nano materials. In some examples, the second and third layers of particles 704, 706 may additionally or alternatively be applied as a surface coating with a similar adhesive such that one or both of the membranes 708, 710 may be omitted. A similar technique may be employed in connection with the example speaker 500 shown in FIG. 5 such that one or both of the membranes 506, 512 may be omitted.

Further, as shown in FIG. 7, unlike the membrane 710 associated with the third layer of particles 706 (which is positioned adjacent an inner surface of the layer of particles 706), the membrane 708 associated with the second layer of particles 704 completely surrounds or encloses the second layer of particles 704. That is, the membrane 708 corresponds to a pouch or sachet that holds the particles therein. In some examples, one or more of the first or third layers of particles 702, 706 may additionally or alternatively be enclosed with a pouch such as the membrane 708 surrounding the second layer of particles 704. Further, a similar technique may be employed in connection with the example speaker 500 shown in FIG. 5 such that one or both of the membranes 506, 512 completely surround the corresponding layers of particles 502, 508.

FIG. 8 shows another example speaker 800 with a speaker box 802 that does not include a side-ported back volume. As shown in the illustrated example, due to the design of the speaker box 802, the layer of particles 804 is limited to the area directly behind the speaker driver 104. This is possible without significantly affecting the overall size (e.g., thickness) of the speaker box 802 because of the small size (e.g., significantly less than 100 micrometers) of the particles to achieve a smaller minimum thickness (of at least 5 layers of stacked-up particles) while still satisfying the minimum acoustic interfering cross-sectional area to depth ratio (of at least 1.5) for meaningful improvement to the audio performance of the speaker 800. Any of the variations in the nature and/or absence of the membranes and/or the location of the layer of the particles discussed above in FIGS. 6 and 7 can be similarly implemented in the example speaker of FIG. 8.

Further, in some examples, any of the layers of particles 502, 508, 702, 704, 706, 804 shown and described in connection with FIGS. 5-8 may be implemented in combination with the example speaker 200 of FIGS. 2 and 3. In many instances, these concepts would not be used in combination because the example of FIGS. 2 and 3 is intended to achieve resonant coupling between the two diaphragms 216, 218, whereas the sound absorbing particles in the examples of FIGS. 5-8 are intended to absorb sound to reduce resonance. However, in at least some cases, depending on the specific design and characteristics of a speaker, at least some amount of sound absorbing particles (as discussed in connection with FIGS. 5-8) may be used in conjunction with a passive extended diaphragm (as discussed in connection with FIGS. 2 and 3).

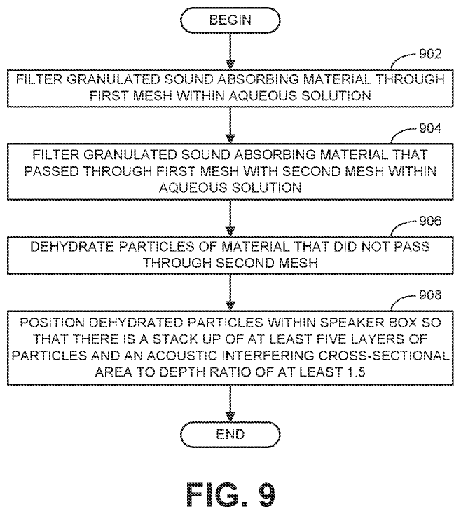

FIG. 9 is a flowchart representative of example operations to implement a method of manufacturing speakers in accordance with teaching disclosed above in connection with FIGS. 5-8. In some examples, some or all of the operations outlined in the FIG. 9 are performed automatically by fabrication equipment that is programmed to perform the operations. Although the example method of manufacture is described with reference to the flowchart illustrated in FIG. 9, many other methods may alternatively be used. For example, the order of execution of the blocks may be changed, and/or some of the blocks described may be combined, divided, re-arranged, omitted, eliminated, and/or implemented in any other way. Further, in some examples, additional processing operations can be performed before, between, and/or after any of the blocks represented in the illustrated example.

The example process of FIG. 9 begins at block 902 by filtering granulated sound absorbing material through a first mesh within an aqueous solution. In some examples, the first mesh includes openings corresponding to a maximum size of particles to be used in a speaker. In some examples, the aqueous solution is employed to overcome the effects of van der Waals forces between the particles. At block 904, the process includes filtering the granulated sound absorbing material that passed through the first mesh with a second mesh in an aqueous solution. In some examples, the second mesh includes openings corresponding to a minimum size of particles to be used in a speaker. In some examples, the aqueous solution used in both blocks 902 and 904 is the same. In other examples, different aqueous solutions may be used. At block 906, the process includes dehydrating the particles of material that did not pass through the second mesh. The dehydration process is to remove all remnants of the aqueous solution. At block 908, the process includes positioning the dehydrated particles within a speaker box so that there is a stack-up of at least five layers of the particles and an acoustic interfering cross-sectional area to depth ratio of at least 1.5. In some examples, the particles are held in position within the speaker box using a permeable membrane to prevent the particles from coming into contact with a speaker driver while allowing sound waves to reach the particles. In other examples, the particles are added as a surface coating that includes an adhesive matrix to retain the particles in position. Thereafter, the example process of FIG. 9 ends.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

From the foregoing, it will be appreciated that example systems, apparatus, articles of manufacture, and methods have been disclosed that improve the bass performance of speakers implemented in relatively small spaces (e.g., speakers for portable devices with back volumes of less than 5 cubic centimeters). In some examples, bass performance is improved by incorporating a passive diaphragm onto the back volume of a speaker to resonate with a diaphragm of an active speaker driver at low frequencies associated with bass sound. Additionally or alternatively, in some examples, bass performance is improved by including relatively thin layers of sound absorbing materials that increase the virtual back volume.

Further examples and combinations thereof include the following:

Example 1 includes a speaker comprising a speaker box having a front face and a back face, the speaker box having a first portion of a back volume and a second portion of the back volume, wherein the first portion of the back volume is defined between the back face and a first region of the front face, wherein the second portion of the back volume is defined between the back face a second region of the front face, wherein the first region of the front face is different from and adjacent to the second region of the front face, an active speaker driver including a first diaphragm, the first diaphragm coupled to the first region of the front face, and a second diaphragm coupled to the second region of the front face, the second diaphragm being passive.

Example 2 includes the speaker of example 1, further including a gasket to surround both the first diaphragm and the second diaphragm.

Example 3 includes the speaker of example 2, wherein the gasket includes an outer rim and an arm extending between opposite sides of the outer rim, the arm separating a first opening of the gasket from a second opening of the gasket, the first diaphragm to be aligned with the first opening in the gasket and the second diaphragm to be aligned with the second opening in the gasket.

Example 4 includes the speaker of example 3, wherein the arm is to overlap an interfacing region of the first and second diaphragms.

Example 5 includes the speaker of example 1, wherein the speaker box includes an internal wall separating the first portion of the back volume from the second portion of the back volume, an edge of the second diaphragm aligned with the internal wall.

Example 6 includes the speaker of example 1, wherein the second diaphragm is composed of the same materials as the first diaphragm.

Example 7 includes the speaker of example 6, wherein the second diaphragm is integrally formed with the first diaphragm.

Example 8 includes the speaker of example 1, further including a weight attached to the second diaphragm and wherein the second diaphragm weighs heavier than the first diaphragm.

Example 9 includes the speaker of example 1, wherein the second diaphragm is more compliant than the first diaphragm.

Example 10 includes the speaker of example 1, wherein an area between the second region of the front face of the speaker box and the back face of the speaker box is non-conductive.

Example 11 includes the speaker of example 1, wherein the back volume is less than approximately 5 cubic centimeters.

Example 12 includes the speaker of example 1, wherein an inner surface the speaker box includes a layer of sound absorbing particles, the sound absorbing particles having a size less than approximately 50 micrometers.

Example 13 includes a portable device comprising a housing, and a speaker disposed within the housing, the speaker including a first diaphragm and a second diaphragm, wherein the first diaphragm is driven by a current provided to a voice coil coupled to the first diaphragm, wherein the second diaphragm is passively driven based on resonance with the first diaphragm, and wherein the first diaphragm extends away from the first diaphragm along a plate of a speaker box of the speaker.

Example 14 includes the portable device of example 13, further including an antenna positioned in proximity to the second diaphragm.

Example 15 includes the portable device of example 13, wherein the portable device is at least one of tablet or a laptop.

Example 16 includes the portable device of example 13, wherein the first diaphragm is adjacent to a first portion of a back volume and the second diaphragm is adjacent to a second portion of the back volume, the second portion side-ported relative to the first portion.

Example 17 includes a method comprising fabricating an active speaker with an extended diaphragm, the active speaker including a first diaphragm, the extended diaphragm corresponding to a second diaphragm distinct from the first diaphragm, and modifying a compliance of the second diaphragm relative to the first diaphragm.

Example 18 includes the method of example 17, wherein the modifying of the compliance of the second diaphragm includes adding weights to the first diaphragm.

Example 19 includes the method of example 18, wherein an amount of the weights added enables the second diaphragm to operate in resonance with the first diaphragm at frequencies between approximately 80 Hz and approximately 200 Hz.

Example 20 includes the method of example 17, further including fabricating the first and second diaphragms in during a single injection molding process.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. A speaker comprising:
a speaker box having a front face and a back face, the speaker box having a first portion of a back volume and a second portion of the back volume, wherein the first portion of the back volume is defined between the back face and a first region of the front face, wherein the second portion of the back volume is defined between the back face a second region of the front face, wherein the first region of the front face is different from and adjacent to the second region of the front face;
an active speaker driver including a first diaphragm, the first diaphragm coupled to the first region of the front face; and
a second diaphragm coupled to the second region of the front face, the second diaphragm being passive.

2. The speaker of claim 1, further including a gasket to surround both the first diaphragm and the second diaphragm.

3. The speaker of claim 2, wherein the gasket includes an outer rim and an arm extending between opposite sides of the outer rim, the arm separating a first opening of the gasket from a second opening of the gasket, the first diaphragm to be aligned with the first opening in the gasket and the second diaphragm to be aligned with the second opening in the gasket.

4. The speaker of claim 3, wherein the arm is to overlap an interfacing region of the first and second diaphragms.

5. The speaker of claim 1, wherein the speaker box includes an internal wall separating the first portion of the back volume from the second portion of the back volume, an edge of the second diaphragm aligned with the internal wall.

6. The speaker of claim 1, wherein the second diaphragm is composed of the same materials as the first diaphragm.

7. The speaker of claim 6, wherein the second diaphragm is integrally formed with the first diaphragm.

8. The speaker of claim 1, further including a weight attached to the second diaphragm and wherein the second diaphragm weighs heavier than the first diaphragm.

9. The speaker of claim 1, wherein the second diaphragm is more compliant than the first diaphragm.

10. The speaker of claim 1, wherein an area the second region of the front face of the speaker box and the back face of the speaker box is non-conductive.

11. The speaker of claim 1, wherein the back volume is less than approximately 5 cubic centimeters.

12. The speaker of claim 1, wherein an inner surface the speaker box includes a layer of sound absorbing particles, the sound absorbing particles having a size less than approximately 50 micrometers.

13. A portable device comprising:
a housing; and
a speaker disposed within the housing, the speaker including a first diaphragm and a second diaphragm, wherein the first diaphragm is driven by a current provided to a voice coil coupled to the first diaphragm, wherein the second diaphragm is passively driven based on resonance with the first diaphragm, and wherein the first diaphragm extends away from the first diaphragm along a plate of a speaker box of the speaker.

14. The portable device of claim 13, further including an antenna positioned in proximity to the second diaphragm.

15. The portable device of claim 13, wherein the portable device is at least one of tablet or a laptop.

16. The portable device of claim 13, wherein the first diaphragm is adjacent to a first portion of a back volume and the second diaphragm is adjacent to a second portion of the back volume, the second portion side-ported relative to the first portion.

17. A method comprising:
fabricating an active speaker with an extended diaphragm, the active speaker including a first diaphragm, the extended diaphragm corresponding to a second diaphragm distinct from the first diaphragm; and
modifying a compliance of the second diaphragm relative to the first diaphragm.

18. The method of claim 17, wherein the modifying of the compliance of the second diaphragm includes adding weights to the first diaphragm.

19. The method of claim 18, wherein an amount of the weights added enables the second diaphragm to operate in resonance with the first diaphragm at frequencies between approximately 80 Hz and approximately 200 Hz.

20. The method of claim 17, further including fabricating the first and second diaphragms in during a single injection molding process.
